(19) United States
(12) Patent Application Publication
(10) Pub. No.: US 2011/0173263 A1
(43) Pub. Date: Jul. 14, 2011

(54) Directing An Attendee Of A Collaboration Event To An Endpoint

(76) Inventors: Ted Beers, Corvallis, OR (US); Jon A. Brewster, Monmouth, OR (US); Lonnie D. Mandigo, Corvallis, OR (US); April S. Mitchell, San Jose, CA (US); Kenton O'Hara, Bristol (GB); Mark E. Gorzynski, Corvallis, OR (US)

(21) Appl. No.: 13/119,772

(22) PCT Filed: Sep. 26, 2008
(86) PCT No.: PCT/US08/77877

§ 371 Date: Mar. 18, 2011

(51) Int. Cl. G06F 15/16

(52) U.S. Cl. 709/204

(57) ABSTRACT

An event management system is configured to receive information that indicates a presence of an attendee of a collaboration event at a first location that is not specified by a registered event specification corresponding to the collaboration event and provide information to the attendee to direct the attendee to a second location with an endpoint for connecting to the collaboration event.

### BACKGROUND

Collaboration event systems allow for collaboration between people in different locations. These systems allow participants to interact with one another through the use of audio and video equipment that provides real time audio and video communications. The process of connecting people across various locations may become complex. The complexity may increase where circumstances of a collaboration event change.

When the circumstances of a collaboration event change, participants of the event may have difficulty altering the event to accommodate the changes. The participants may be unfamiliar with the collaboration event system that implements the event or may have limited knowledge about the event itself. As a result, the participants may have little ability to alter the event to accommodate the changes.

### BRIEF DESCRIPTION OF THE DRAWINGS

FIG. 1 is a block diagram illustrating one embodiment of a collaboration event system.

FIGS. 2A-2B are block diagrams illustrating embodiments of an event endpoint.

FIGS. 3A-3B are block diagrams illustrating embodiments of configurations of audio/video devices.

FIG. 4 is a flow chart illustrating an embodiment of a method performed by an event management system.

FIGS. 5A-5D are block diagrams illustrating embodiments of locations for interacting with an event management system.

FIG. 6 is a block diagram illustrating one embodiment of an event managed by an event management system.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense.

As described herein, an event management system manages collaboration events such as video teleconferences. The event management system maintains registered event specifications for each collaboration event and dynamic event context information that describes the status of collaboration events relative to each other. The event management system uses the registered event specifications and the dynamic event context information to optimize the interaction between collaboration events. The event management system also includes event endpoint information and policies that describe relationships among endpoints and rules associated with endpoints and event attendees.

The event management system enables and facilitates attendee participation in collaboration events by applying policies in consideration of the status of attendee presence. To do so, the event management system uses pre-registered and/or updated attendee information and event context information to adjust the topology of the event to include the attendee at a new event endpoint or otherwise adjust the participation of the attendee in the event. The event management system considers and adjusts to changes in the presence information of the attendee to identify and implement an optimal way of having the attendee participate in the event.

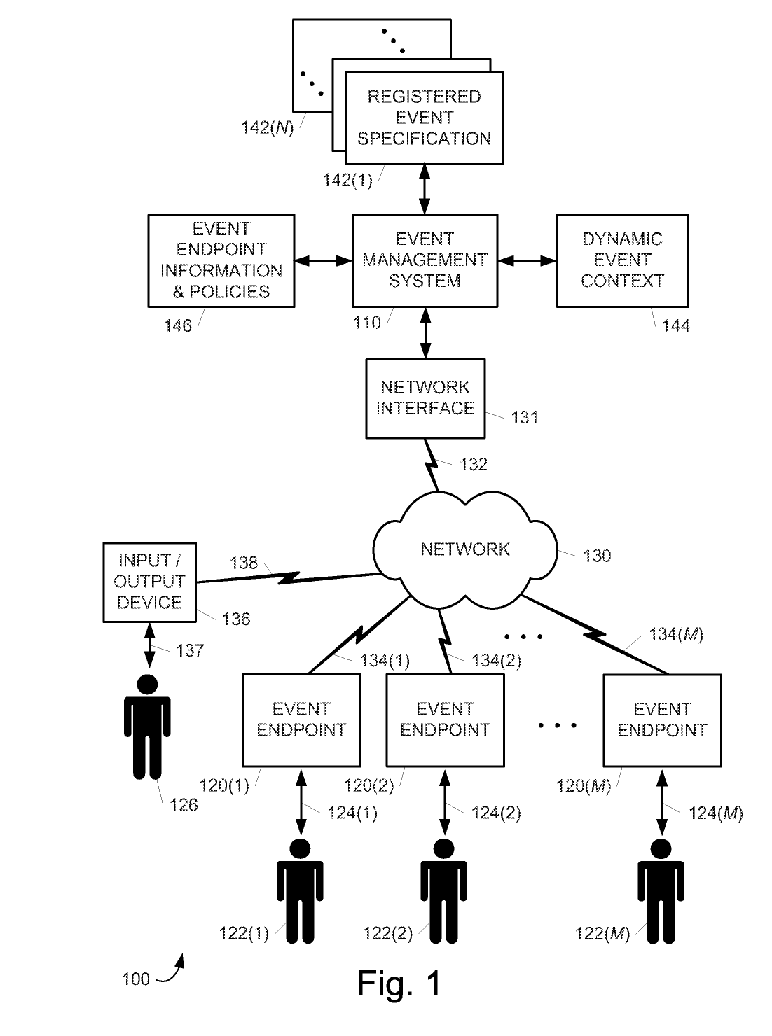

FIG. 1 is a block diagram illustrating one embodiment of a collaboration event system 100. Collaboration event system 100 includes an event management system 110, a set of event endpoints 120(1)-120(M), and a network 130 that interconnects event management system 110 and event endpoints 120.

Collaboration event system 100 is configured to create and host collaboration events. A collaboration event is an activity with experiential relevance to people, possessing an extension in time and location. Examples of a collaboration event (hereafter “event”) include telepresence videoconferences and meetings conducted using collaboration studio such as a “Halo studio” offered by Hewlett-Packard Co. For each event, collaboration event system 100 exchanges a selected set of audio and/or video (A/V) media streams 124(1)-124(M) between a selected set or subset of event endpoints 120(1)-120(M).

An event includes a set of collaboration system topologies, each of which include a set or subset of event endpoints 120(1)-120(4). An event also includes a registered event specification 142 that specifies information such as a unique identity token, a purpose, a list of event attendees, a list of event resources, contact information of a host of the event, a priority of the event, start and end dates and times, and/or an event duration. Event resources may include event endpoints 120, physical locations (e.g., a collaboration studio or conference room), input/output devices 136 (e.g., interactive touchpoints), and attendees 122.

The collaborative event may take place in two or more locations (e.g., different cities) that each have an event endpoint 120 to connect a set of one or more attendees 122 or media resources in each of the locations. Cameras and microphones, for example, may capture video and audio from one or more of the locations (i.e., at one endpoint) and the video and audio may be output using one or more display devices and speakers, for example, at one or more other locations (i.e., one or more other endpoints). In addition, various types of pre-recorded A/V data, such as content from a DVD, may be transported to one or more of the locations where it may be output using a display device or speakers, for example. One or more locations of the collaborative event may include arrangements of office furniture (e.g., office chairs and a conference table) and A/V gear to provide persons with gaze awareness and a full immersive feeling.

Event management system 110 is configured to initiate, execute, host, and optimize collaboration events using registered event specifications 142(1)-142(N), dynamic event context 144, and event endpoint information and policies 146. Each event is registered with event management system 110, either in advance (i.e., scheduled ahead of time) or in real time (i.e., scheduled on an ad hoc basis), to create a registered event specification 142 for the event using any suitable device for accessing event management system 110 (e.g., an event endpoint 120 or an input output device 136). Event management system 110 may reference and use each registered event specification 142 for various purposes including preparation for and execution of an event in accordance with the information in a registered event specification 142.

Dynamic event context 144 is real-time information that describes the status of events (e.g., in-progress, interrupted, extended, etc.), the status of events relative to each other (e.g., overlapping or not overlapping based on the start and end times of events), the status of event endpoints 120 and other media resources (e.g., available, reserved, in use or otherwise occupied, or unavailable), and the status of attendees 122 (e.g., checked-in at an event endpoint 120 or elsewhere or not checked-in along with any special privilege indicators or other attendee designations) for each event. Event management system 110 generates and maintains dynamic event context 144 to monitor and manage the real-time system status of collaboration event system 100.

Endpoint information and policies 146 describes the locations, topologies, configurations, and operation policies of event endpoints 120(1)-120(M). Event management system 110 accesses event endpoint information and policies 146 for use in configuring and optimizing collaboration events. Event management system 110 may also reference and use other system information such as the time of day in the process of managing collaboration events.

Each event endpoint 120(1)-120(M) provides a respective set of one or more attendees 122(1)-122(M) with a respective set of one or more audio and/or visual media streams 124(1)-124(M) using network 130. Each event endpoint 120 includes any suitable type, number, and combination of audio and/or visual input and/or output devices that are configured to generate, provide, and/or receive the respective set of media streams 124. Media streams 124 may each be any suitable combination of live or pre-recorded audio and/or video data and/or collaborative data such as XML data that may be combined in any suitable way and output to any number of attendees 122 in any number of event endpoints 120 by collaboration event system 100. Each set of attendees 122(1)-122(M) includes one or more people where the number of people may stay the same, increase, or decrease during the course of an event. In addition, the set of event endpoints 120 for an event may stay the same, increase, or decrease during the course of an event.

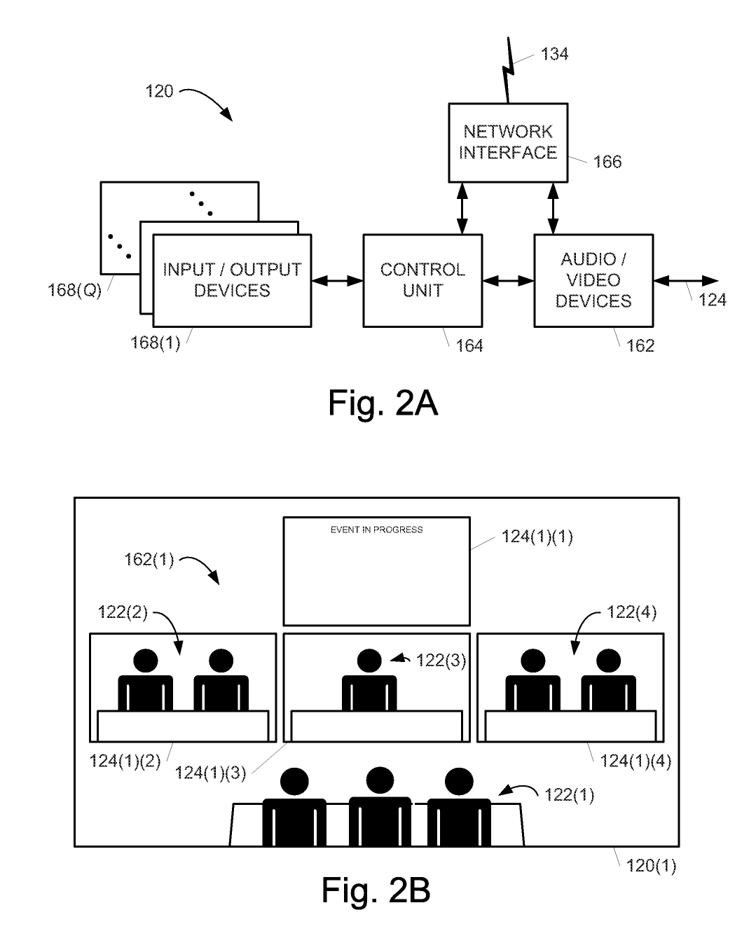

FIGS. 2A-2B are block diagrams illustrating embodiments of event endpoint 120. In the embodiment of FIG. 2A, event endpoint 120 includes a set of one or more audio and/or video (A/V) devices 162, a control unit 164, a network interface 166 and a set of one or more input/output (I/O) devices 168(1)-168(Q).

A/V devices 162 includes any type, number, and combination of audio and/or video input and/or output devices. Examples of A/V input devices include microphones, still and video cameras, media players, and computer and storage systems. The A/V input devices capture, detect, receive or otherwise input live or pre-recorded media streams 124 and provide the input media streams 124 to control unit 164 and/or network interface 166. Examples of A/V output devices include speakers, headphones, headsets, media recorders, and display devices such as projectors, computer monitors, and televisions. The A/V output devices receive media streams from control unit 164 and/or network interface 166 and provide, display, play, or otherwise output live or pre-recorded media streams 124.

Control unit 164 manages the operation of event endpoint 120 by providing control signals and/or other information to and receiving control signals and/or other information from A/V devices 162, network interface 166 and input output devices 168(1)-168(Q). In some embodiments, control unit 164 may perform processing on media streams received from A/V devices 162 and/or network interface 166 prior to the media streams being provided to network interface 166 or output by A/V devices 162. The processing may include coding or decoding media streams from one media and/or network format to another media and/or network format.

Network interface 166 includes any suitable type, number, and/or combination of network devices that allow event endpoint 120 to communicate with network 130 (shown in FIG. 1) using network connection 134. Network interface 166 receives media streams across network connection 134 and provides the media streams to control unit 164 and/or A/V devices 162. Network interface 166 also receives media streams from control unit 164 and/or A/V devices 162 and provides the media streams to network 130 using network connection 134.

I/O devices 168(1)-168(Q) include any suitable type, number, and/or combination of input and/or output devices that allow attendees 122, administrators, or other persons to communicate with event endpoint 120. The communications may cause event endpoint 120 and/or collaboration event system 100 to perform functions indicated by attendees 122, administrators, or other persons. Examples of I/O devices 168 include interactive touchpoints, display screens, keyboards, and selection or navigation devices (e.g., a mouse, joystick, flywheel, or touchpad).

In other embodiments, the functionality of an A/V device 162 and an I/O device 168 may be included in a single unit such as a laptop computer. In addition, other embodiments may include A/V devices 162 but omit I/O devices 168 or may include I/O devices 168 but omit A/V devices 162.

FIG. 2B illustrates an embodiment of the operation of endpoint 120(1). Endpoint 120(1) provides attendees 122(1) who are present at endpoint 120(1) with media streams 124(1)(1)-124(1)(4) using any suitable type and/or combination of audio/video devices 162(1). Audio/video devices 162(1) are configured to allow for gaze awareness and a full immersion feeling for attendees 120(1).

In the example of FIG. 2B, media stream 124(1)(1) provides information about the event attended by attendees 122(1) (e.g., status information, notifications, configuration options, etc.) and media streams 124(1)(2)-124(1)(4) provide audio and video representations of by attendees 122(2)-122(4), respectively, who are present at event endpoints 120(2)-120(4), respectively. Attendees 122(1)-122(4) collectively represent the set of attendees who are present for the event illustrated by the example of FIG. 2B. In other embodiments, endpoint 120(1) may provide other numbers of media streams 124(1) to attendees 120(1) and may have other configurations of audio/video devices 162(1) relative to attendees 120(1).

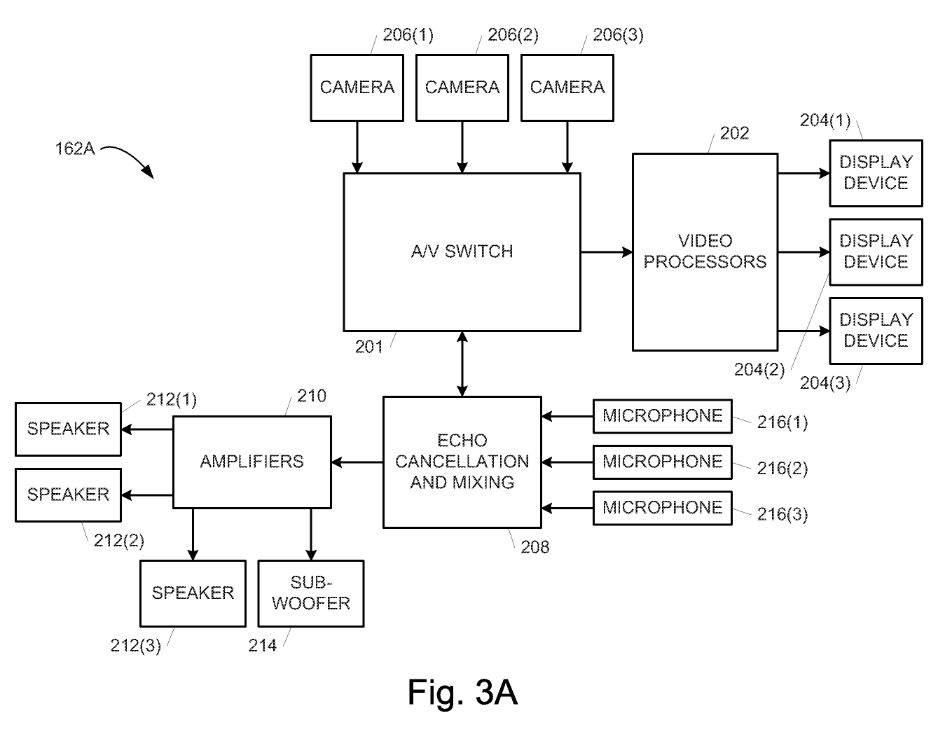

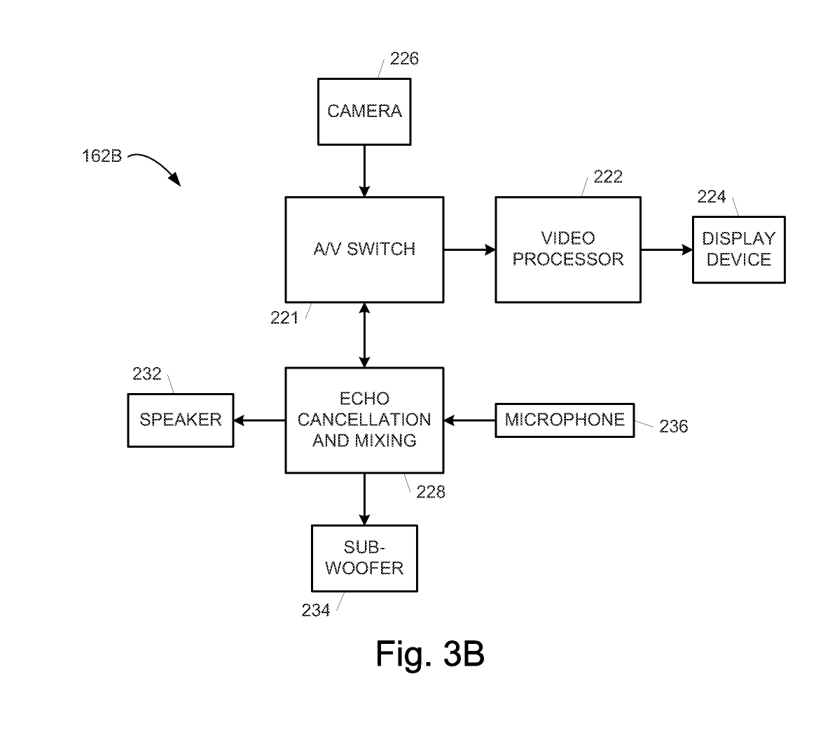

FIGS. 3A-3B are block diagrams illustrating embodiments of configurations of audio/video devices 162.

In one embodiment, A/V devices 162 includes integrated A/V gear that forms a collaboration studio such as a “Halo studio” offered by Hewlett-Packard Co. as shown in the embodiment 162A of FIG. 3A. In the embodiment of FIG. 3A, video processors 202 provide video data from A/V switch 201 to display devices 204(1)-204(3), and display devices 204(1)-204(3) display the video data. Cameras 206(1)-206(3) capture video data and provide the video data to A/V switch 201. An echo cancellation and mixing unit 208 mixes and processes audio data from A/V switch 201 and provides the processed audio data to amplifiers 210. Amplifiers 210 amplify the audio data and provide the audio data to speakers 212(1)-212(3) and sub-woofer 214. Speakers 212(1)-212(3) output the higher frequencies of the audio data, and sub-woofer 214 outputs the lower, bass frequencies of the audio data. Microphones 216(1)-216(3) capture audio data and provide the audio data to A/V switch 201.

Display devices 204(1)-204(3) may be arranged in such a manner around a conference table and chairs to allow for gaze awareness and a full immersion feeling in one embodiment.

In another embodiment, A/V devices 162 includes A/V gear as shown in the embodiment 162B of FIG. 3B. In the embodiment of FIG. 3B, video processor 222 provides video data from A/V switch 221 to display device 224, and display device 224 displays the video data. Camera 226 captures video data and provides the video data to A/V switch 221. An echo cancellation and mixing unit 228 mixes and processes audio data from A/V switch 221 and provides the processed audio data to speaker 232 and sub-woofer 234. Speaker 232 outputs the higher frequencies of the audio data, and sub-woofer 234 outputs the lower, bass frequencies of the audio data. Microphone 236 captures audio data and provides the audio data to A/V switch 221 through echo cancellation and mixing unit 228.

Referring back to FIG. 1, network 130 may be any suitable type of network or combination of networks formed from any suitable number, type, and or combination of network devices (not shown). The network devices may operate using any suitable network protocol or protocols and may connect to any suitable number of event endpoints 120 or other computer or storage systems. Network 130 may include any suitable combination of secure networks (e.g., enterprise networks or corporate intranets) with limited and secure connections to other systems or unsecure networks with at least one unsecure connection to another system.

Network 130 may be a local, regional, or global network of any suitable network configuration that ranges from local point-to-point connections between event management system 110 and event endpoints 120 to a global array of connections that interconnect event management system 110 and event endpoints 120. Network 130 may be private or publicly available and include one or more connections to the Internet.

Network 130 may be designed specifically to optimize high bandwidth with low latency to be able to transport live, interactive, audio, video, and other data rich media streams. Network 130 may have a smallest link of 45 Mbps, in one embodiment, to avoid any significant serialization delay. Network 130 may also use a flat network topology to minimize latency. In order to keep a high quality end-user experience, network 130 may keep the total one-way latency between any event endpoints 120 to less than one-quarter of a second. This total latency may encompass all aspects of encoding/decoding, encapsulation/de-encapsulation, capture and presentation, filtering, processing, compression and decompression, image compositing, and transport latencies across the transmission path. As the contribution of each component of network 130 to overall latency decreases (as technology improves), the length of the “reach” of where different sites can be physically located may be increased.

To better preserve the shortest paths capable of reliable delivery with little packet loss, bandwidth and network resource mechanisms (not shown) may be used to insure high-quality sessions for the duration of the collaboration session. As most traffic streams are presumed to take place linking a pair or small number of event endpoints 120 together for any given session, event management system 110 may have little presumption of event pre-emption once authorized events commence. In some embodiments, longer latency and/or loss tolerant sessions may be provided over network 130. Such services may include directory, presence, messaging, credential verification, calibration, and time/name services for examples.

The interior of network 130 may concentrate on speedy delivery of traffic flows. Any access control, encryption/decryption and other proxy services, if needed, may occur at the edge of network 130 such as in event endpoints 120 and not the interior of network 130 in some embodiments. This design may make the core of the backbone of network 130 simpler to grow, maintain, stablize, and attain the desired latency.

Event management system 110 connects to network 130 using a network interface 131 and a network connection 132, and event endpoints 120(1)-120(M) connect to network 130 using respective network connections 134(1)-134(M). Each network connection 132 and 134(1)-134(M) may include any suitable type, number, and/or combination of wired or wireless network connections. For example, network connections 132 and 134(1)-134(M) may each be a leased line (i.e., a T3, optical, cable, or wireless high speed link) which provides a large data pipe to and from event management system 110, event endpoints 120(1)-120(M), and input/output device 136, respectively.

Input/output (I/O) device 136 may be any suitable type of device (e.g., a portable or non-portable device such as an interactive touchpoint, a computer, a cell phone, a media player, or a personal digital assistant) configured to communicate with event management system 110 and thereby form an event management client. I/O device 136 is configured to receive inputs from a person 126 and/or provide outputs to person 126 as indicated by an arrow 137. The inputs and outputs may include audio and/or video inputs and outputs. I/O device 136 connects to network 130 using any suitable wired or wireless network connection 138. I/O device 136 may be omitted in some embodiments.

Person 126 may be associated with an event in various ways. For example, person 126 may be an organizer or registered attendee of an event who is identified by registered event specification 142 for the event. Person 126 may also be someone acting on behalf of an organizer or registered attendee identified by registered event specification 142 for the event. Person 126 may further be attempting to register for the event by adding his or her name to registered event specification 142 for the event. In addition, person 126 may be located at or near an event endpoint 120 for the scheduled event.

In operation, event management system 110 initiates, executes, hosts, and optimizes collaboration events using registered event specifications 142(1)-142(N), dynamic event context 144, and event endpoint information and policies 146.

Event management system 110 initiates execution of an event by allocating resources for creating a real-time representation of the event according to the registered event specification 142 of the event to optimize the experience of attendees 122 and 126. The allocated resources include the set or a subset of event endpoints 120 as indicated by the registered event specification 142. Event management system 110 continues execution of the event with changes to the topology of the event (e.g., the addition or removal of event endpoints 120 during the event) to maintain and optimize the experience of attendees 122 and 126 and ends as dictated by the registered event specification 142 or by external inputs (e.g., from an attendee 122 and 126). During execution, event management system 110 may describe an event as being “in-progress”.

In preparation for event execution (i.e., during event preparation) and during event execution, certain activities may be performed by event resources or event management system 110 that impact the management of the event, such as an attendee 122 checking in at an endpoint location, an input/output device associated with an endpoint, or another location. During the course of the lifecycle of an event, additional related artifacts may be added to the event, such as an archive of the execution of the event.

Event management system 110 optimizes event preparation and event execution for each registered event that requires various resources including those resources whose states may impact event preparation and execution. The optimization accounts for resources that may be in use by one or more in-progress events, resources that may be unavailable (e.g., requested for use by another event or out of service), key event attendees 122 that are missing, and other critical event information. Event management system 110 also optimizes event execution for in-progress events by preventing unwanted disruption of an event using resources required by the registered event and by handling requests for resources made by other events.

Event management system 110 performs the optimization using registered event specifications 142 for all related events including the primary event being prepared and other events in progress that are consuming needed resources and dynamic event context information 144 which includes information about event resources (e.g., resources used by other in-progress events and other status information about needed resources). Event management system 110 may also perform the optimization using information provided by attendees, administrators, and/or other persons via I/O devices 168 (shown in FIG. 2A) and/or 136 associated with the event in progress and the registered events and event endpoint information and policies 146. Event endpoint information and policies 146 includes information about the physical and assigned relationships among resources, including relationship information about event endpoints 120 and I/O devices 168 and/or 136, policies regarding the management of shared resources to facilitate optimal event execution, and principles governing the systems behaviors in consideration of the multitude of registered and dynamic information.

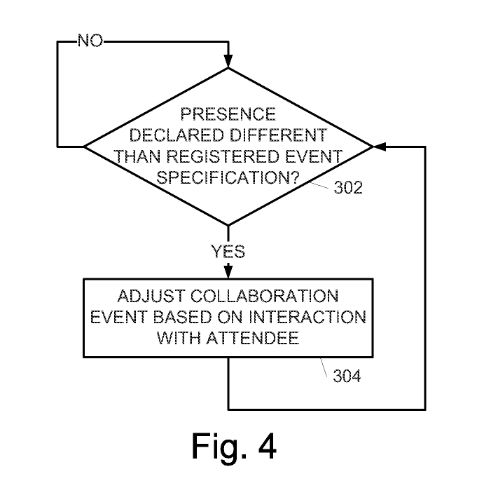

Event management system 110 enables and facilitates attendee participation in collaboration events by applying policies in consideration of the status of attendee presence as illustrated in the embodiment of FIG. 4. Event management system 110 uses pre-registered information from a registered event specification 142 and/or updated attendee information received from an attendee 126 along with dynamic event context 144 to adjust the topology of an event to include the attendee 126 at a new event endpoint 120 or otherwise adjust the participation of the attendee 126 in the event. Event management system 110 considers and adjusts changes to the presence information of the attendee 126 in the registered event specification 142 to identify and implement an optimal way of having the attendee 126 participate in the event.

In the following description of FIGS. 4-6, person 126 (FIG. 1) will be referred to as attendee 126 of a collaboration event. Attendee 126, however, may represent a person acting on behalf of an attendee of an event in some embodiments.

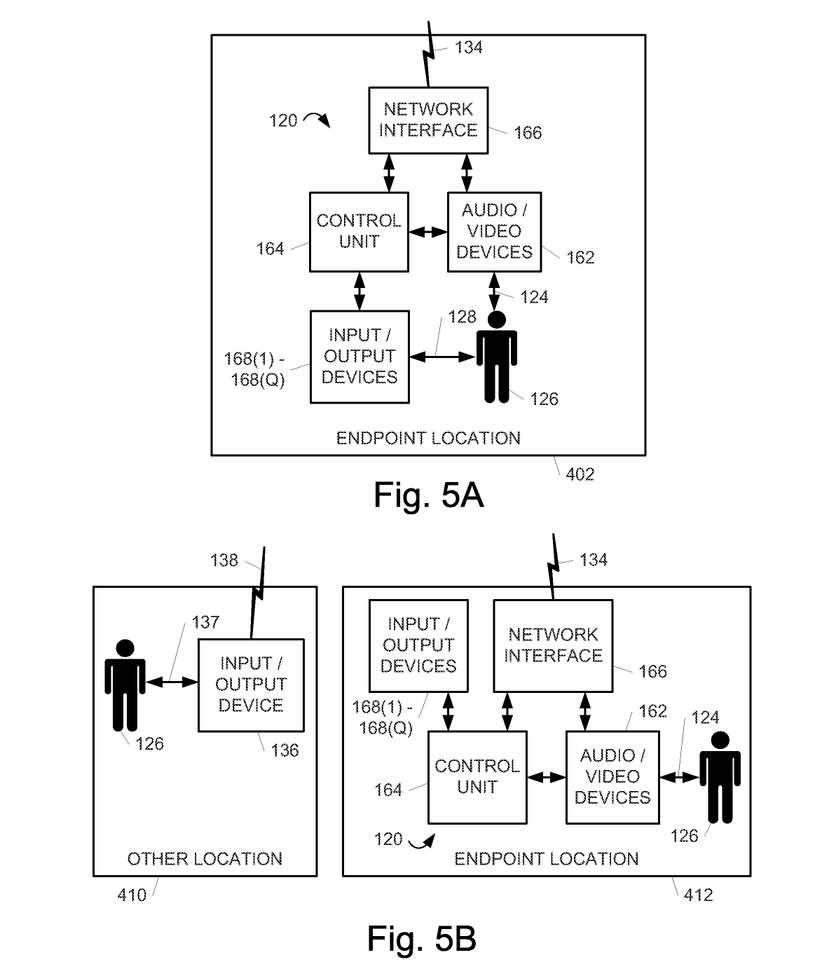

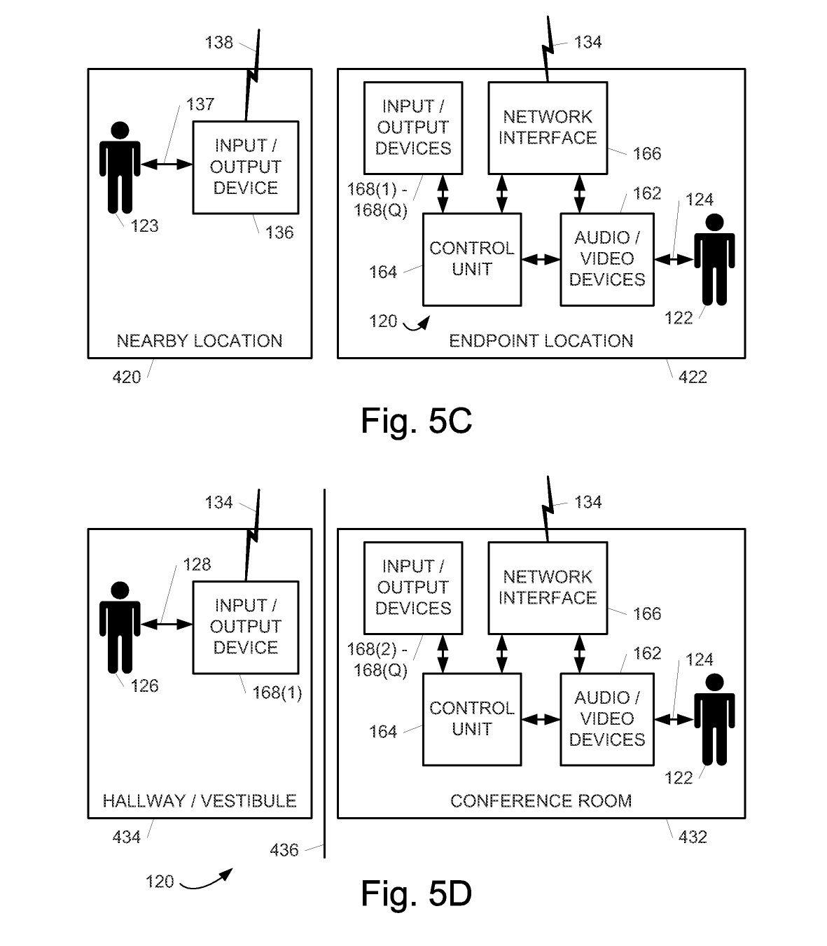

FIG. 4 is a flow chart illustrating an embodiment of a method performed by event management system 110. In FIG. 4, event management system 110 determines whether a declared presence of an attendee 126 of an event differs from a registered event specification 142 for the event as indicated in a block 302. Attendee 126 declares his or her presence by providing attendee information (e.g., checking in) to event management system 110 using an I/O device 136 or an I/O device 168 from any suitable location as will be described in additional detail with reference to FIGS. 5A-5D below. The attendee information may identify the attendee 126 specifically (e.g., by name or other identifier) or generally (e.g., as an attendee of a designated event or an attendee at an event endpoint location known to event management system 110).

In response to receiving an initial communication from attendee 126, event management system 110 may initiate a series of interactions with attendee 126 to cause the attendee information to be received. For example, event management system 110 may prompt attendee 126 to provide information such as contact or location information. Event management system 110 may also provide prompts that are selectable by attendee 126 to cause desired functions to be performed by event management system 110.

In response to receiving attendee information from attendee 126, event management system 110 associates attendee 126 with an in progress or a scheduled event by determining a relationship between attendee 126 and an in progress or a scheduled event. The relationship may depend on an identity of attendee 126 or a location of attendee 126. In one embodiment, event management system 110 associates attendee 126 with an in progress or a scheduled event by matching attendee information received from attendee 126 (e.g., a name, an event code, or other identifier) with information in a registered event specification 142 for the in progress or the scheduled event. In another embodiment, event management system 110 associates attendee 126 with an in progress or a scheduled event by matching location information received from attendee 126 with location information in a registered event specification 142 for the in progress or the scheduled event and/or event endpoint information and policies 146. For example, event management system 110 may recognize an input/output device 168 as the source of a communication from attendee 126 and determine that attendee 126 is at an endpoint that includes the input/output device 168 using event endpoint information and policies 146. From these determinations, event management system 110 associates attendee 126 with an in progress or scheduled event.

After associating attendee 126 with an event, event management system 110 determines whether the declared presence of attendee 126 differs from the registered event specification 142 for the event. The declared presence may differ from the registered event specification 142 by indicating an arbitrary location of attendee 126 that is not specified by the registered event specification 142 (i.e., a location that differs from or is remotely located from all of the locations of event endpoints 120 listed in registered event specification 142) and/or by being received at a time that is not near a time for the event (i.e., the presence is declared well before the event) as specified by the registered event specification 142.

If event management system 110 determines that the declared presence of attendee 126 differs from the registered event specification 142 for the event, then event management system 110 adjusts the collaboration event based on interactions with attendee 126 as indicated in a block 304. Event management system 110 adjusts the collaboration event to accommodate the change of circumstances of attendee 126. In particular, event management system 110 adjusts the collaboration event to allow attendee 126 to participate in the event.

The change made by event management system 110 depends on the location or anticipated location of attendee 126 at the time of the event. Event management system 110 determines this location from the attendee information and/or interacts with attendee 126 to determine an alternative event endpoint 120 at the location.

The alternative event endpoint 120 may be an endpoint 120 that attendee 126 uses to declare his or her presence to event management system 110 as illustrated by the example of FIG. 5A. FIG. 5A is a block diagram illustrating an embodiment of an endpoint location 402 for interacting with event management system 110. In FIG. 5A, attendee 126 accesses any of input/output devices 168(1)-168(Q) (e.g., an interactive touchpoint or touchpad display) inside of event endpoint 120 to declare a presence with event management system 110 as indicated by arrow 128. In this case, event management system 110 may verify that the endpoint 120 is available for use by the event using dynamic event context 144 and/or registered event specifications 142 for other events. If available, event management system 110 reserves the endpoint 120 for the event and adjusts the event topology to include the attendee 126 from this endpoint 120. Event management system 110 causes media streams 124 of the event to be provided to and received from attendee 126 at endpoint location 402.

The alternative event endpoint 120 may also be selected by attendee 126 by providing, for example, a phone number or IP address to event management system 110 as illustrated in FIG. 5B. FIG. 5B is a block diagram illustrating an embodiment of a location 410 for interacting with event management system 110. In FIG. 5B, attendee 126 uses an input/output device 136 (e.g., a mobile device) to declare a presence with event management system 110 and provide contact information to event management system 110 as indicated by arrow 137. Event management system 110 uses the contact information from attendee 126 to adjust the event topology to include the attendee 126 using an endpoint 120 specified by the contact information. The endpoint 120 may be an endpoint 120 at a location 412 that is selected by attendee 126 with the contact information or the I/O device 136 used to declare the presence with event management system 110 at location 410. Event management system 110 causes suitable media streams of the event to be provided to and received from attendee 126 at the endpoint 120 at location 412 or the I/O device 136 at location 410.

The alternative event endpoint 120 may further be selected by event management system 110 by identifying an endpoint 120 that is near a location 420 of attendee 126 as illustrated in FIG. 5C. FIG. 5C is a block diagram illustrating an embodiment of nearby location 420 for interacting with event management system 110. In FIG. 5C, attendee 126 uses an input/output device 136 (e.g., a mobile device) to declare a presence with event management system 110 and provide location information to event management system 110 as indicated by arrow 137. Event management system 110 identifies and selects an endpoint 120 at a location 422 that is near location 420 using the location information and event information and policies 146. Event management system 110 may verify that the endpoint 120 at location 422 is available for use by the event using dynamic event context 144. If available, event management system 110 reserves the endpoint 120 at location 422 for the event, provides information to the attendee 126 to direct the attendee 126 to the location of the endpoint 120, and adjusts the event topology to include the attendee 126 from this endpoint 120. Event management system 110 causes media streams 124 of the event to be provided to and received from attendee 126 at endpoint location 422.

The alternative event endpoint 120 may additionally be an I/O device 168 outside of an endpoint 120 that attendee 126 uses to declare his or her presence to event management system 110 as illustrated in FIG. 50. FIG. 5D is a block diagram illustrating an embodiment of an endpoint 120 for interacting with event management system 110. In FIG. 50, attendee 126 accesses an input/output device 168(1) (e.g., an interactive touchpoint or touchpad display) of event endpoint 120 to declare a presence with event management system 110 as indicated by arrow 128.

In the embodiment of FIG. 5D, event endpoint 120 includes a conference room 432 and a hallway or vestibule 434 outside of conference room 432 as indicated by a barrier 436. Barrier 436 may be a wall, a door, a corridor, or other suitable physical structure or space that separates conference room 432 from hallway or vestibule 434. Input/output device 168(1) is located in hallway or vestibule 434 adjacent to or otherwise nearby conference room 432. Input/output device 168(1) is associated with event endpoint 120 with a physical connection (e.g., a wired or wireless network connection 134) or other information that specifies the physical arrangement of input/output device 168(1) in event endpoint 120. Attendee 126 may use input/output device 168(1) without visually or audibly interrupting an in progress event taking place in conference room 432.

Audio/video devices 162 of endpoint 120 that provide media streams 124 to and/or capture media streams 124 from attendees 122 of an event that is in progress inside conference room 432 are located inside conference room 432. Input/output device 168(1) is located outside conference room 432. Although other components of endpoint 120 are shown as being inside conference room 432 in the embodiment of FIG. 5D, some or all of these components may be located outside of or adjacent to conference room 432 in other embodiments (e.g., in a control room (not shown)).

Event management system 110 may detect that the conference room 432 is unavailable for use by the event using dynamic event context 144 (e.g., the conference room 432 is being used or will be used by another event). Accordingly, event management system 110 may either connect attendee to the event using I/O device 168 or direct the attendee 126 to another nearby endpoint 120 (shown in FIG. 5C). Event management system 110 adjusts the event topology to include the attendee 126 from I/O device 168 or the other endpoint 120. Event management system 110 causes media streams of the event to be provided to and received from attendee 126 using I/O device 168 or the other endpoint 120.

In some instances of the above examples, the alternative endpoint 120 may turn out to be an endpoint 120 that is already specified by the registered event specification 142 for the event. This may occur where the attendee 126 happens to be at a location of an endpoint 120 that was expected to be used by other attendees 122 of the event. Accordingly, event management system 110 provides information to the attendee 126 to direct the attendee 126 to the location of the endpoint 120 and adjusts the event topology to include the attendee 126 from this endpoint 120 along with other attendees 122 for the event.

If all attendees 122 and 126 of an event happen to declare their presence in physical proximity to each other, event management system 110 may recognize this occurrence and reconfigure a nearby endpoint 120 to operate as a conventional meeting room or direct all attendees 122 and 126 to a nearby conventional meeting room.

As part of adjusting the event topology, event management system 110 adjusts the registered event specification 142 of the event to add the location of the alternative endpoint 120 and/or the new location of attendee 126. Event management system 110 may also adjust the registered event specification 142 to remove an endpoint 120 that may be unused as a result of the attendee 126 connecting to the event at a different location.

Event management system 110 may perform the method of FIG. 4 for each attendee 126 that declares a presence at a location that differs from the locations specified in the registered event specification 142 for the event.

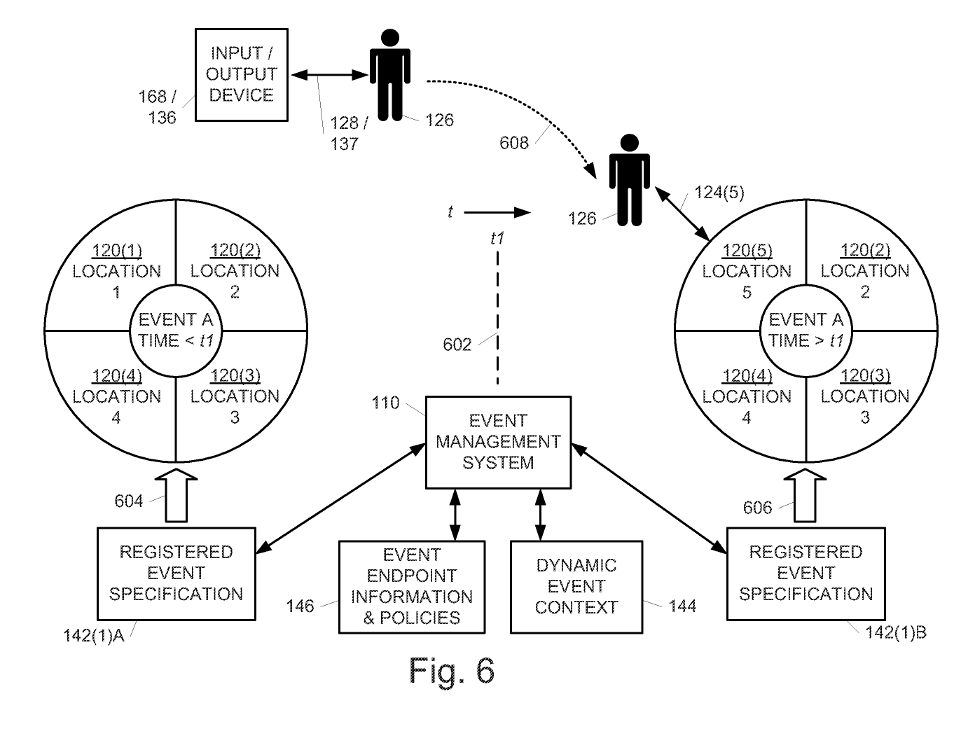

An example of event management system 110 directing an attendee 126 to an alternative endpoint 120 will now be described with reference to FIG. 6. FIG. 6 is a block diagram illustrating one embodiment of an event A managed by event management system 110 before and after time t1. Event A may begin prior to or around time t1. Prior to time t1, registered event specification 142(1)A specifies endpoints 120(1)-120(4) at respective locations 1-4 as indicated by an arrow 604 and as depicted on one side of a line 602 that represents time t1.

At time t1, attendee 126 registers his or her presence with event management system 110 at a location that is not specified by registered event specification 142(1)A using either an I/O device 168 at an endpoint 120 as indicated by arrow 128 or an I/O device 136 as indicated by arrow 137. In particular, attendee 126 registers his or her presence at a location that differs from location 1 that registered event specification 142(1)A specifies as the location where attendee 126 is scheduled to connect the event.

From the known location of I/O device 168 or a location indicated by attendee 126, event management system 110 recognizes that attendee 126 is not at location 1. Event management system 110 identifies and selects an endpoint 120(5) at a location 5 that is near the known location of I/O device 168 or a location indicated by attendee 126 using event information and policies 146. Event management system 110 verifies that endpoint 120(5) is available for use by the event using dynamic event context 144. If available, event management system 110 reserves endpoint 120(5) for event A and adds endpoint 120(5) to registered event specification 142(1)A to create registered event specification 142(1)B. Because attendee 126 is the only attendee of event A scheduled to use endpoint 120(1), event management system 110 also removes endpoint 120(1) from registered event specification 142(1)B. Accordingly, subsequent to time t1, registered event specification 142(1)A specifies endpoints 120(2)-120(5) at respective locations 2-5 as indicated by an arrow 606 and as depicted on the other side of line 602 that represents time t1.

Event management system 110 provides information to the attendee 126 using I/O device 168 or 136 to direct the attendee 126 to endpoint 120(5). Attendee 126 moves to endpoint 120(5) as indicated by a dashed arrow 608 where media streams 124(5) of the event are provided to attendee 126 and received from attendee 126 subsequent to time t1.

Event management system 110 may also direct any other attendees 122 of event A (not shown) that are in physical proximity of endpoint 120(5) to endpoint 120(5).

In the above embodiments, event management system 110 may include any suitable combination of hardware and software components. In one embodiment, event management system 110 includes one or more programs that is stored in any suitable type, number, and/or combination of portable or non-portable storage media (not shown) within or otherwise accessible to event management system 110. The programs are accessible to and executable by any suitable type, number, and/or combination of processors (not shown) in event management system 110 to perform the functions described above.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the optical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited by the claims and the equivalents thereof.

What is claimed is:

1. A method performed by an event management system, the method comprising:
receiving first information that indicates a presence of a first attendee of a collaboration event at a first location that is not specified by a registered event specification corresponding to the collaboration event; and
providing second information to the first attendee to direct the first it) attendee to a second location with an endpoint for connecting to the collaboration event.

2. The method of claim 1 further comprising:
adjusting the registered event specification to specify the second location.

3. The method of claim 1 wherein the first location differs from the second location.

4. The method of claim 1 further comprising:
selecting the second location based on the first information.

5. The method of claim 1 further comprising:
receiving an indication of the second location in the first information from the first attendee.

6. The method of claim 1 further comprising:
causing a set of media streams of the collaboration event to be provided to and received from the first attendee at the endpoint.

7. The method of claim 1 wherein the first information identifies the attendee.

8. The method of claim 1 wherein the first information identifies the collaboration event.

9. The method of claim 1 further comprising:
providing third information to a second attendee of the collaboration event to direct the second attendee to the second location.

10. A program product comprising:
a program executable by a processor for causing the processor to:
receive first information that indicates a first presence of a first attendee of a collaboration event at a first location that differs from a first specified location for the first attendee in a registered event specification corresponding to the collaboration event; and
providing second information to the first attendee to direct the first attendee to a second location with a first endpoint for connecting to the collaboration event;
a medium that stores the program so that the program is accessible by the processor.

11. The program product of claim 10 wherein the program is executable by the processor for causing the processor to:
receive third information that indicates a second presence of a second attendee of the collaboration event at a third location that differs from a second specified location for the second attendee in the registered event specification; and
providing fourth information to the second attendee to direct the second attendee to a third location with a second endpoint for connecting to the collaboration event.

12. The program product of claim 10 wherein the program is executable by the processor for causing the processor to:
adjust the registered event specification to specify the second location.

13. The program product of claim 10 wherein the first location differs from the second location.

14. The program product of claim 10 wherein the program is executable by the processor for causing the processor to:
cause a set of media streams of the collaboration event to be provided to and received from the first attendee at the first endpoint.

15. The program product of claim 10 wherein the program is executable by the processor for causing the processor to:
provide third information to a second attendee of the collaboration event to direct the second attendee to the second location.

16. A system comprising:
a network interface configured to connect to a network; and
an event management system coupled to the network interface, including a registered event specification of a collaboration event that is configured to include at least first and second event endpoints that provide a first set of media streams to a set of attendees;
wherein the event management system is configured to detect a presence of a first one of the set of attendees at a first location that is remotely located from each of the first and the second event endpoints using the network interface, and wherein the event management system is configured to provide first information that directs the first one of the set of attendees to a second location with a third event endpoint using the network interface in response to detecting the presence.

17. The system of claim 16 wherein the event management system is configured to add the third event endpoint to the registered event specification.

18. The system of claim 16 wherein the registered event specification includes the third event endpoint prior to detecting the presence.

19. The system of claim 16 wherein the event management system includes event information that indicates that the second location is near the first location.

20. The system of claim 16 wherein the event management system includes at least one of a registered event specification and dynamic event context information that indicates that the third event endpoint is available for use by the collaboration event.
